(19) United States
(12) Patent Application Publication
(10) Pub. No.: US 2011/0161061 A1
(43) Pub. Date: Jun. 30, 2011

(54) COLLISION SIMULATION METHOD OF THREE DIMENSIONAL OBJECT

(75) Inventors: Jun-Mein Wu, Keelung City (TW); Chia-Chen Chen, Hsinchu City (TW); Wen-Shiou Luo, Hsinchu City (TW)

(73) Assignee: Industrial Technology Research Institute, Hsinchu (TW)

(21) Appl. No.: 12/775,479

(22) Filed: May 7, 2010

(30) Foreign Application Priority Data
Dec. 31, 2009 (TW) 98146179

(51) Int. Cl. G06F 17/10

(52) U.S. Cl. 703/2

(57) ABSTRACT

A collision simulation method of a three dimensional (3D) object is provided, wherein the 3D object is composed of a plurality of polygonal meshes. First, a collision between the polygonal meshes and an object is detected. When one of the polygonal meshes is collided by the object, at least one virtual vertex is generated at a first position where the polygonal mesh is collided by the object, wherein the polygonal mesh includes a plurality of vertexes. Then, the virtual vertex is connected to the vertexes to form a plurality of sub meshes. Next, a force between the object and the virtual vertex is calculated to update the first position of the virtual vertex into a second position. After that, forces between the virtual vertex and the vertexes are calculated according to the second position of the virtual vertex so as to update the positions of the vertexes.

### CROSS-REFERENCE TO RELATED APPLICATION

This application claims the priority benefit of Taiwan application serial no. 98146179, filed on Dec. 31, 2009. The entirety of the above-mentioned patent application is hereby incorporated by reference herein and made a part of specification.

### BACKGROUND OF THE INVENTION

1. Field of the Invention

The disclosure relates to a simulation method of a three dimensional (3D) object, and more particularly, to a collision simulation method of a 3D object.

2. Description of Related Art

In recent years, three dimensional (3D) image simulation techniques have matured and broadly applied. Besides, 3D games and 3D animations, these 3D simulation techniques are also applied in the medical field and to 3D designs and fashion designs. For example, 3D simulation have been applied to operation simulation, facial recovery, plastic surgery, human engineering, stress and strain analysis, object movement simulation, online shopping, fashion design, garment simulation, shoe design, and shoe simulation, etc.

Generally speaking, a 3D moving object is simulated through either a spring model or finite element analysis. The spring model technique is based on a simple theory and offers a high calculation speed. However, this technique lacks precision. The finite element analysis technique is commonly used in engineering and offers high precision. However, this technique usually requires a large amount of data in its calculation and accordingly a long calculation time and a large memory. Thus, the finite element analysis technique is not applicable to any application that requires real-time response. On the other hand, the finite element analysis technique requires a 3D object to be a regular network model therefore is not applicable to those irregular 3D models that are not produced through computer-aided design (CAD).

In physics, the change of appearance of an object when the object receives an external force is usually calculated by using a spring model. In spring model simulation, a 3D object is usually composed of many triangular meshes, and vertexes of the triangular meshes are connected by springs. The spring force is calculated according to the Hooke's law Fᵢ=kΔLᵢⱼ, wherein ΔLᵢⱼ=(Lᵢⱼ−Lᵢⱼ⁰). Lᵢⱼ, Lᵢⱼ⁰, and k respectively represent the length of the spring when it receives the external force, the length of the spring before it receives the external force, and a spring constant.

Usually parameters (for example, a position pᵢ, a velocity vᵢ, and a mass mᵢ) of every vertex in the spring model are initialized before the simulation starts. Then, the force Fᵢ (for example, an external force (gravity) and an internal force (the spring deformation force)) received by the object and the acceleration (aᵢ=Fᵢ/mᵢ) of the object are calculated. Next, the velocity (vᵢⁿ=vᵢaᵢΔt) of the next moment is calculated by using the acceleration. Next, the position (pᵢⁿ=pᵢ+vᵢⁿΔt) of the object is calculated by using the updated velocity. After that, the force and the acceleration of the next moment are calculated by using the new position and the new velocity, and the position and the velocity are then further updated. Accordingly, the physical response (deformation and movement, etc) of the object at any moment can be calculated.

However, the standard implementation of the spring model has some disadvantages. For example, no additional constraint can be added to a standard spring model (for example, a specific angle has to be kept between two planes, or each spring has to be maintained at a fixed length, etc) so that errors may be produced in the simulation result. In addition, when an object collides with another object, it is difficult to describe the physical responses between vertexes and meshes. Moreover, the deformation of an object can only be precisely described with a smaller Δt. However, all the vertexes need to be updated in unit of Δt when the deformation of the object at a next moment is calculated. Thus, the smaller Δt is, the more frequently the vertexes are updated. Accordingly, the calculation load is increased and the efficiency is reduced along with the decrease of Δt.

### SUMMARY OF THE INVENTION

Accordingly, the disclosure is directed to a collision simulation method of a three dimensional (3D) object, wherein the precision of a collision response is improved and the use of a memory is reduced.

The disclosure provides a collision simulation method of a 3D object, wherein the 3D object is composed of a plurality of polygonal meshes. The collision simulation method includes following steps. A collision between the polygonal meshes and an object is detected. When one of the polygonal meshes is collided by the object, at least one virtual vertex is generated at a first position where the polygonal mesh is collided by the object, wherein the polygonal mesh includes a plurality of vertexes. The at least one virtual vertex is connected to the vertexes to form a plurality of sub meshes. A force between the object and the at least one virtual vertex is calculated to update the first position of the at least one virtual vertex into a second position. Forces between the at least one virtual vertex and the vertexes are calculated according to the second position of the at least one virtual vertex, so as to update the positions of the vertexes.

As described above, in the disclosure, the simulation precision is improved by generating at least one virtual vertex at where a 3D object is collided.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of a collision simulation method of a three dimensional (3D) object according to an embodiment of the present invention.

FIGS. 2A-2G are partial views of the 3D object in FIG. 1.

FIG. 3 illustrates detailed steps of the collision simulation method in FIG. 1.

FIG. 4 illustrates a step of quantifying time steps in a collision simulation method of a 3D object according to an embodiment of the present invention.

FIG. 5A and FIG. 5B respectively illustrate a plurality of vertexes before and after time steps thereof are quantified.

FIG. 6 illustrates the timing of updating the vertexes in FIG. 5B.

FIGS. 7A-7H illustrate the timing of quantifying the vertexes in FIG. 5A into 4 time steps.

FIG. 8 is a flowchart of a model correction method extended from the collision simulation method in FIG. 1.

FIG. 9 is a flowchart of a collision simulation method of a 3D object according to another embodiment of the present invention.

### DESCRIPTION OF THE EMBODIMENTS

Reference will now be made in detail to the embodiments, examples of which are illustrated in the accompanying drawings. Wherever possible, the same reference numbers are used in the drawings and the description to refer to the same or like parts.

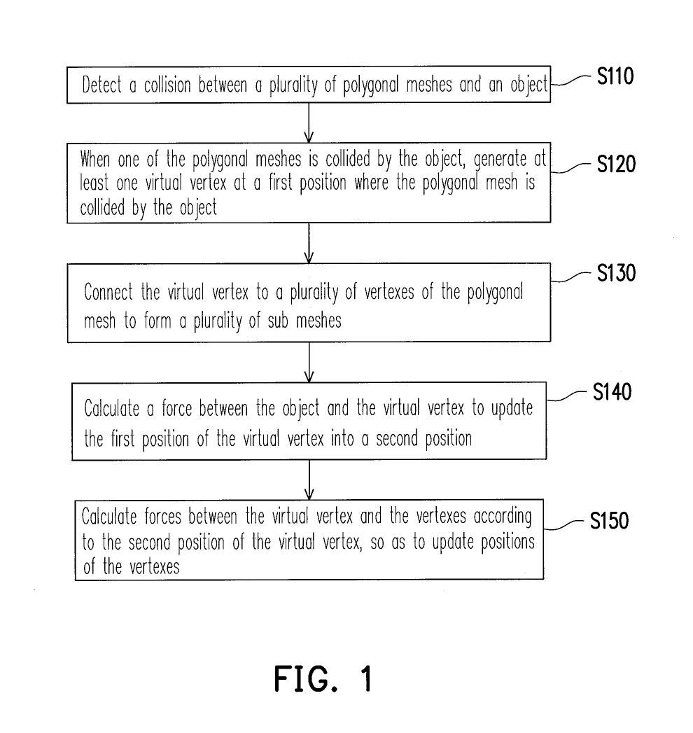

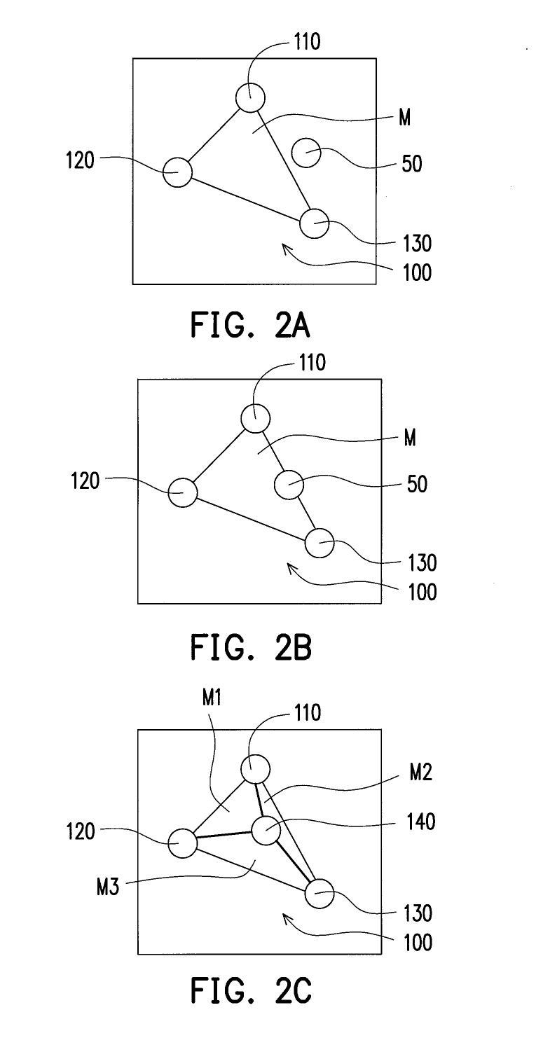

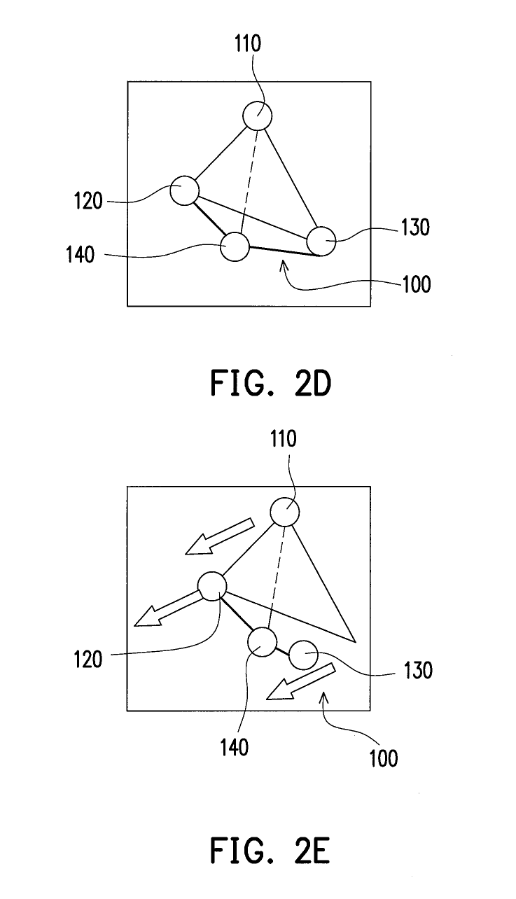

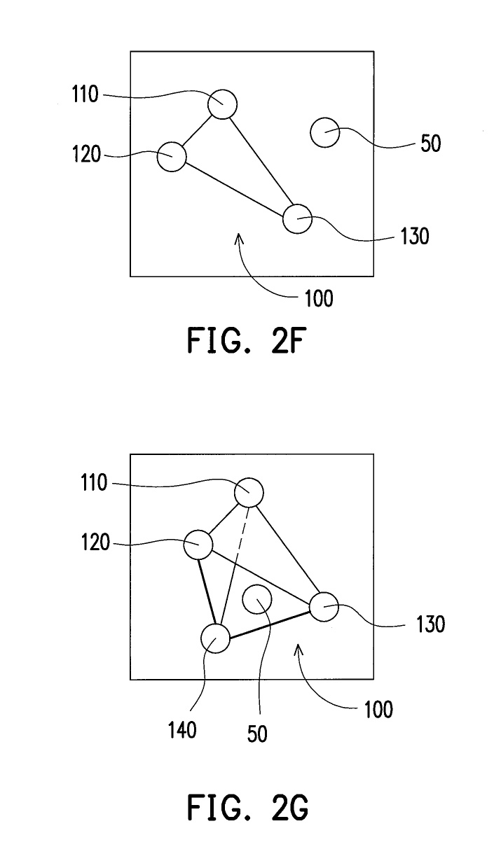

FIG. 1 is a flowchart of a collision simulation method of a three dimensional (3D) object according to an embodiment, and FIGS. 2A-2G are partial views of the 3D object in FIG. 1. Below, the simulation of a collision between a 3D object 100 and an object 50 will be described with reference to FIG. 1 and FIGS. 2A-2G. The 3D object 100 is composed of a plurality of polygonal meshes (only a polygonal mesh M composed of three vertexes 110, 120, and 130 is illustrated demonstratively in FIG. 2A). In the present embodiment, the polygonal meshes are respectively triangular meshes. However, the present invention is not limited thereto.

First, in step S110, a collision between the polygonal meshes and the object 50 is detected. In physical response simulation, the situation that the 3D object 100 receives an external force may also be considered as that the 3D object 100 is collided by an object for the convenience of simulation. Generally speaking, there are two types of collisions. One is collisions between a vertex and a mesh (including collisions between vertexes), and the other one is collisions between meshes. Regarding the collision detection between objects, a bounding box checking, a same side checking, a numerical imprecision checking, an intersection vertex checking, and a record minimal-distance are sequentially performed in the present embodiment.

The bounding box checking operation is first performed during the collision detection process. In the bounding box checking operation, the maximum extension ranges of the 3D object 100 and the object 50 are recorded. Whether the 3D object 100 and the object 50 overlap each other can be roughly determined through the determination of the maximum extension ranges. It is determined that no collision occurs if the two do not overlap each other, and the subsequent same side checking operation is performed if the two overlap each other. If all of foregoing checking is passed, it is determined that the 3D object 100 collides with the object 50. Herein those areas on the 3D object 100 that are impossible to be collided may be deleted in order to reduce the subsequent calculation load. Next, the position on the 3D object 100 collided by the object 50 is calculated and recorded.

Thereafter, in step S120, when it is detected that the polygonal mesh M is collided by the object 50, a virtual vertex 140 is generated in the polygonal mesh M at a first position collided by the object 50 (as shown in FIG. 2C). In the present embodiment, the collision between the object 50 and the polygonal mesh M is a collision between a vertex and a mesh. Thus, only one virtual vertex 140 is generated in the polygonal mesh M. However, the present invention is not limited thereto. In another embodiment that is not illustrated, other virtual vertexes may be generated within the area collided by the object 50 on the polygonal mesh M if the collision between the object 50 and the polygonal mesh M is a collision between meshes.

After that, in step S130, the virtual vertex 140 is connected to the vertexes 110, 120, and 130 to form a plurality of sub meshes M1, M2, and M3 (as shown in FIG. 2C). Accordingly, unlike in other polygonal meshes in the 3D object 100, the distribution density of vertexes in the collided polygonal mesh M increases along with the number of the virtual vertex 140. Thus, the collision process can be simulated with more vertexes and accordingly the simulation precision can be improved. In addition, because the distribution density of vertexes in other polygonal meshes remains unchanged, the calculation load regarding other polygonal meshes also remains unchanged. Thereby, the calculation load of the system is not increased very much with the improved simulation precision.

Next, in step S140, a force between the object 50 and the virtual vertex 140 is calculated to update the first position of the virtual vertex 140 into a second position (as shown in FIG. 2D). For example, the force of the collision may be calculated according to the mass and acceleration of the object 50.

Thereafter, in step S 150, forces between the virtual vertex 140 and the vertexes 110, 120, and 130 are calculated according to the second position of the virtual vertex 140 so as to update the positions of the vertexes 110, 120, and 130 (as shown in FIG. 2E). In the present embodiment, the forces between the virtual vertex 140 and the vertexes 110, 120, and 130 are calculated in a spring model.

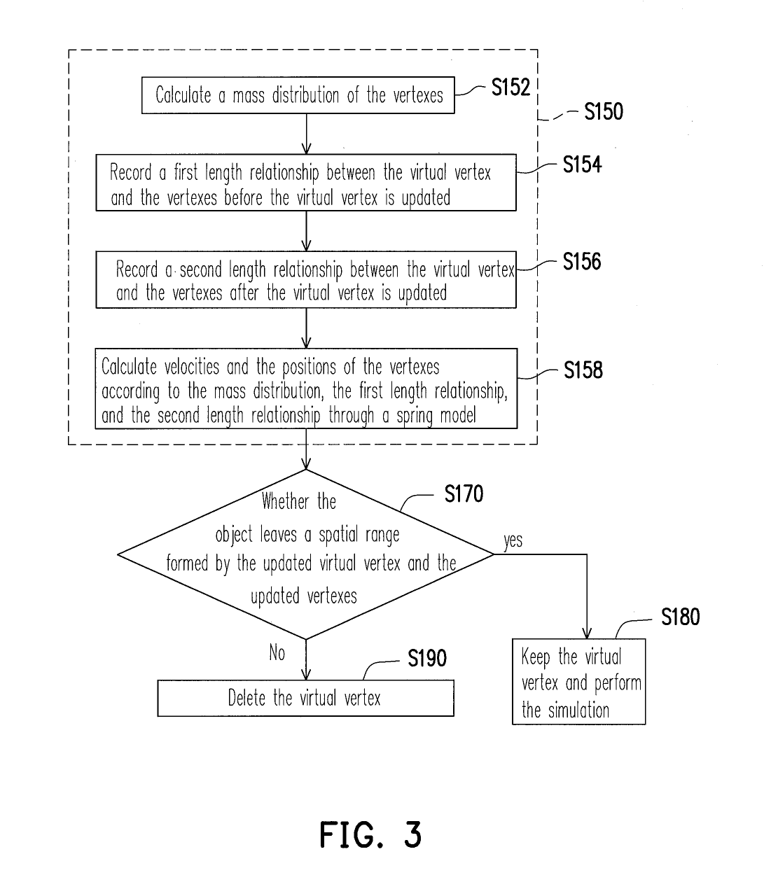

FIG. 3 illustrates detailed steps of the collision simulation method in FIG. 1. How to calculate the forces in the spring model will be described herein with reference to FIG. 1 and FIG. 3. Foregoing step S150 further includes a plurality of sub steps S152-S158. First, in step S152, a mass distribution of the vertexes 110, 120, and 130 is calculated. To be specific, the mass (mᵢ=Σ_{j∈nearby}ⁿρⱼAⱼ) of each vertex is calculated by using the surface area and density of adjoining vertexes, wherein ρⱼ represents the density of adjoining vertexes, and Aⱼ represents the surface area of adjoining vertexes. For example, the mass of the vertex 110 is m₁₁₀₌ρⱼ×((surface area of sub mesh M1)+(surface area of sub mesh M2)). Herein the value of ρⱼ is determined according to the actual requirement.

Next, in step S154, a first length relationship between the virtual vertex 140 and the vertexes 110, 120, and 130 before the virtual vertex 140 is updated is recorded. As shown in FIG. 2C, the lengths Lᵢ^{v} between the virtual vertex 140 and the vertexes 110, 120, and 130 are respectively recorded as initial conditions of the Hooke's law in spring simulation.

In step S156, a second length relationship between the virtual vertex 140 and the vertexes 110, 120, and 130 after the virtual vertex 140 is updated is recorded. As shown in FIG. 2D, the lengths Lᵢ^{v}+ΔLᵢ^{v} between the virtual vertex 140 and the vertexes 110, 120, and 130 are respectively recorded after the position of the virtual vertex 140 is updated.

Thereafter, in step S158, the velocities and positions of the vertexes 110, 120, and 130 are calculated according to the mass distribution, the first length relationship, and the second length relationship through the spring model. To be specific, the forces received by the vertexes 110, 120, and 130 from the object 50 are calculated through the simple spring model as Fᵢ=kₛΔAΔLᵢ^{v}, wherein Fᵢ is an external force, kₛ is a predetermined elastic modulus of the spring model, and ΔLᵢ^{v} is the difference between the first length relationship and the second length relationship.

To be more specific, steps S170-S190 are further executed after the positions of the vertexes 110, 120, and 130 are updated (step S150). First, in step S170, whether the object 50 leaves a spatial range formed by the updated virtual vertex 140 and vertexes 110, 120, and 130 is determined. If the object 50 leaves the spatial range, step S180 is executed to delete the virtual vertex 140 (as shown in FIG. 2F) so that the 3D object 100 resumes its state before the collision occurs. However, if the object 50 does not leave the spatial range yet, it is determined that the collision is still ongoing. In this case, step S190 is executed to keep the virtual vertex 140 in the simulation (as shown in FIG. 2G). Because physical simulation is also carried out regarding the sub meshes M1, M2, and M3 generated according to the virtual vertex 140, the simulation precision is improved. The virtual vertex 140 is deleted to reduce the calculation load once the object 50 leaves the meshes.

It should be mentioned that conventionally the physical response of a collision between a vertex and a mesh is usually processed in a rigid way. However, since most objects are not rigid bodies, the actual situation cannot be truthfully presented through the rigid technique, and the error produced may directly affect the simulated result. Instead, in the present embodiment, the actual situation when a collision between a vertex and a polygonal mesh occurs can be truthfully presented by generating virtual vertexes at the position where the polygonal mesh is collided.

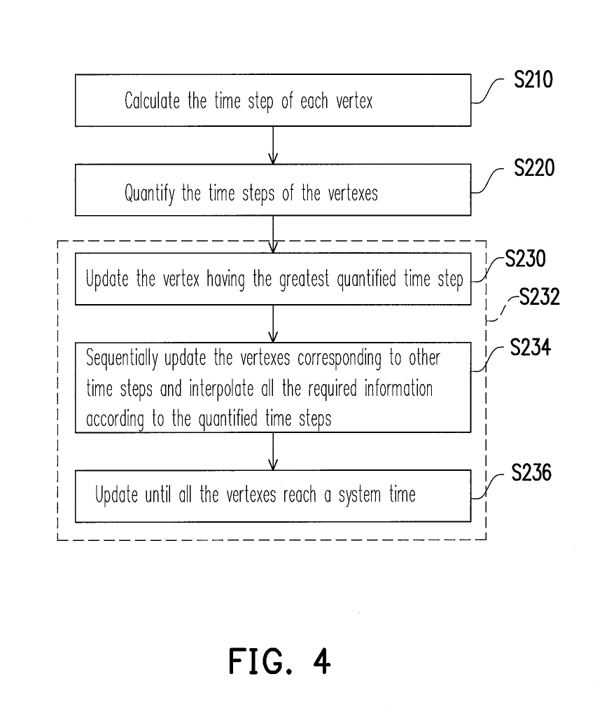

FIG. 4 illustrates a step of quantifying time steps in a collision simulation method of a 3D object according to an embodiment of the present invention. Referring to FIG. 4, first, in step S210, the time steps of the vertexes 110, 120, and 130 are calculated. The smallest time step may be selected as the time step Δtᵢ=min(Δt_{c1},Δt_{c2}) of each of the vertexes 110, 120, and 130, wherein Δt_{c1} and Δt_{c2} are convergence conditions.

Since each vertex may be connected to more than one vertex, the smallest value is selected as Δt of the vertex. The movement of the vertex is considered linear during this Δt. Thus, in order to achieve a precise physical simulation, the time step Δt has to be small enough to ensure the convergence of the simulated result. However, each vertex Vᵢ is in different surroundings therefore receives a different external force. Thus, each vertex Vᵢ requires different time step to ensure the convergence thereof. In the present embodiment, the appropriate convergence condition Δt_{c1}=c₁(ΔLᵢⱼ/Δvᵢⱼ) and Δt_{c2}=c₂\sqrt{mᵢ/Fᵢ} of each vertex is first given, wherein c₁ and c₂ are two constants that can be adjusted by a user, ΔLᵢⱼ represents the spring deformation between two vertexes, and Δvᵢⱼ represents the relative velocity between two vertexes. Based on actual experiments, c₁ and c₂ have to be smaller than 0.01 in order to allow the simulated result to converge. If c₁ and c₂ are greater than 0.01, the simulated result may emanates.

Next, the time steps of the vertexes 110, 120, and 130 are quantified. For example, the time steps Δtᵢ of the vertexes 110, 120, and 130 may be quantified into Δtᵢ^{q}=2ⁱ⁻¹Δt₁, wherein i≧1, and Δt₁ is the smallest one among the time steps of the vertexes 110, 120, and 130.

Next, the vertexes 110, 120, and 130 are sequentially updated according to the quantified time steps Δtᵢ^{q} until the vertexes 110, 120, and 130 respectively reach a system time, wherein the system time is the greatest one among the quantified time steps Δtᵢ^{q} of the vertexes 110, 120, and 130.

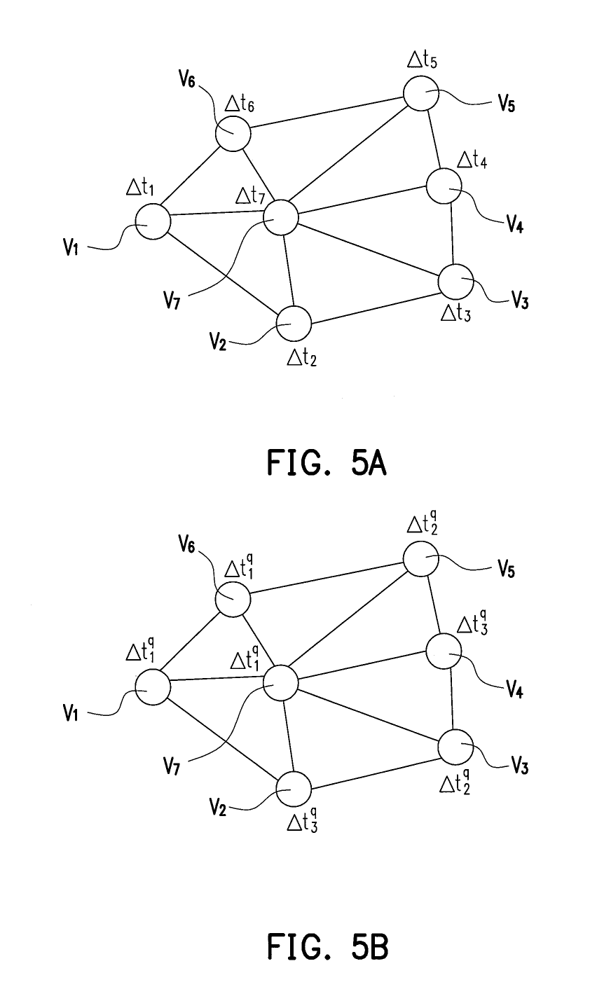

FIG. 5A and FIG. 5B respectively illustrate a plurality of vertexes before and after time steps thereof are quantified. Referring to FIG. 5A and FIG. 5B, an example of quantifying the time steps Δt₁₋Δt₇ of 7 vertexes V₁₋V₇ into 3 time steps Δt₁^{q}, Δt₂^{q}, and Δt₃^{q} will be described herein in order to explain the process of quantifying time steps illustrated in FIG. 4, wherein Δt_{3>}^{q}Δt_{2>}^{q}Δt₁^{q}. To be specific, the time steps are quantified by selecting the smallest time step (for example, the time step Δt₁) among the time steps of all the vertexes V₁₋V₇ and quantifying the selected time step into the time step Δt₁^{q}, wherein Δt₂_{₌₂}^{q}Δt₁, and Δt₂_{₌₄}^{q}Δt₁.

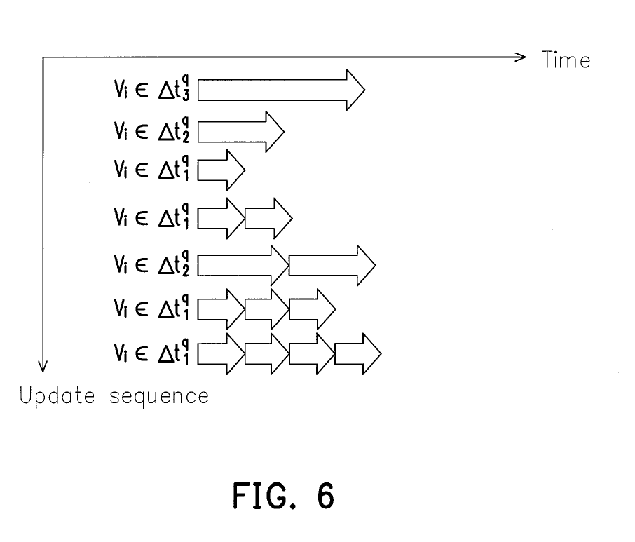

FIG. 6 illustrates the timing of updating the vertexes in FIG. 5B. Referring to FIG. 5B and FIG. 6, first, the vertexes V₂ and V₄ corresponding to the greatest time step Δtᵢ^{q} (Δt₃^{q}) are updated. Then, the vertexes V₃ and V₅ corresponding to the time step Δt₂^{q} are updated. Next, the vertexes V₁, V₆, and V₇ corresponding to the time step Δt₁^{q} are updated. This will go on until the vertexes respectively reach a system time Δt₃^{q}. Only the vertexes corresponding to the time step Δtᵢ^{q} is updated every time, and any other vertex information (for example, positions and velocities) can be obtained through linear interpolation. Thus, the time of the entire simulation process is effectively shortened through the technique described above.

It should be mentioned that in the conventional simulation technique, the smallest time step is selected as the system time step Δt_{sys}=min(Δtᵢ). After obtaining the system time step Δt_{sys}, the force and collision detection of each vertex are then calculated and performed to obtain the new position of the vertex. However, all the vertexes have to be updated every time when the Δt_{sys} is updated. Thus, the simulation efficiency is very low. Instead, in the present embodiment, time steps Δtᵢ having different values are quantified into the time steps Δtᵢ^{q} and every time only vertexes corresponding to the time step Δtᵢ^{q} are updated, so that the simulation efficiency is greatly improved.

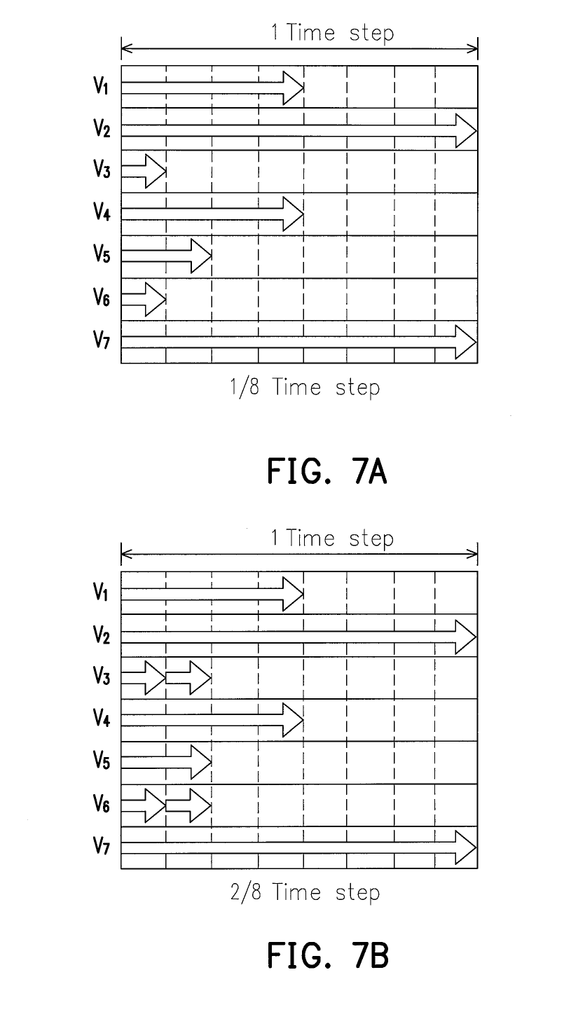

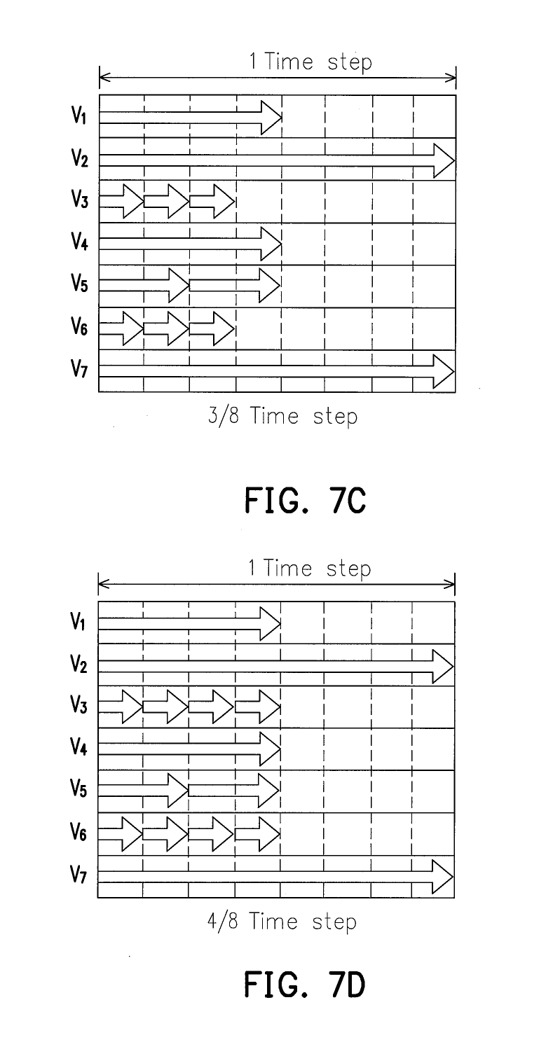

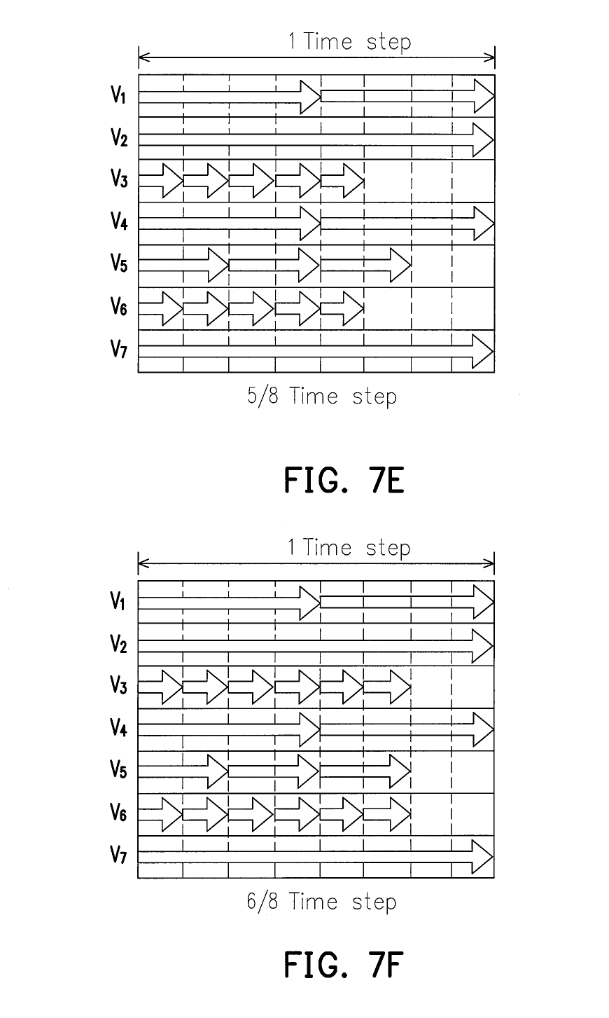

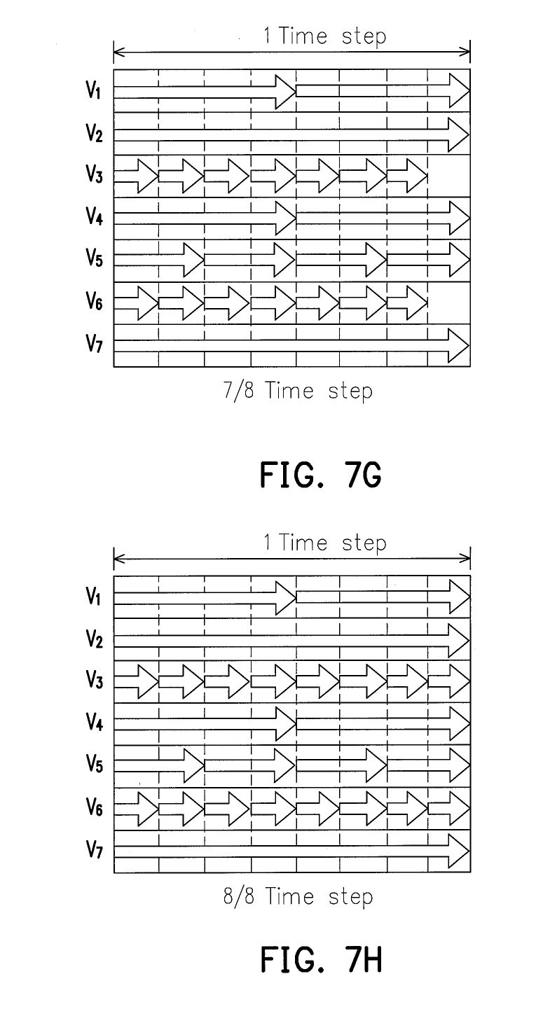

FIGS. 7A-7H illustrate the timing of quantifying the vertexes in FIG. 5A into 4 time steps. In following description, the time steps are classified into 8 time steps according to the actual situation. Referring to FIG. 7A, first, the time steps Δtᵢ^{q} of all the vertexes V₁₋V₇ are respectively updated. Herein the vertexes V₂ and V₇ corresponding to the greatest time step Δtᵢ^{q} are already updated. Then, referring to FIG. 7B, the vertexes V₃ and V₆ are updated so that the time steps of the vertexes V₃, V₅, and V₆ become identical. Next, referring to FIG. 7C, the vertexes V₃, V₅, and V₆ are updated so that the time steps of the vertexes V₁, V₄, and V₅ become identical. After that, referring to FIG. 7D, the vertexes V₃ and V₆ are updated so that the time steps of the vertexes V₁, V₃, V₄, V₅, and V₆ become identical. Referring to FIG. 7E, the vertexes V₁, V₃, V₄, V₅, and V₆ are updated so that the time steps of the vertexes V₁, V₂, V₄, and V₇ become identical. Next, referring to FIG. 7F, the vertexes V₃ and V₆ are updated so that the time steps of the vertexes V₃, V₅, and V₆ become identical. Thereafter, referring to FIG. 7G, the vertexes V₃, V₅, and V₆ are updated so that the time steps of the vertexes V₁, V₄ and V₅ become identical. Finally, referring to FIG. 7H, the vertexes V₃ and V₆ are updated so that the time steps of all the vertexes V₁₋V₇ become identical.

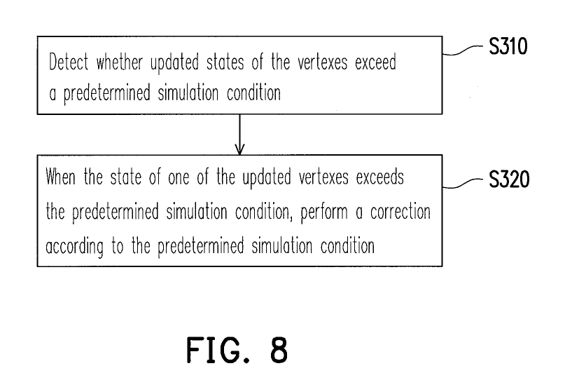

FIG. 8 is a flowchart of a model correction method extended from the collision simulation method in FIG. 1. Generally speaking, most models have limitations in their movement. For example, a fixed bending angle or distance must exist between two planes, or a specific area on a model has to be kept at a specific vertex or a specific area in the space. Accordingly, a model correction process is further provided in the present embodiment in order to simulate the model more truthfully. Referring to FIG. 1 and FIG. 8, while updating the vertexes 110, 120, and 130, whether the states of the updated vertexes 110, 120, and 130 exceed a predetermined simulation condition is detected (step S310). To be specific, the detection can be classified into two types. One is static detection, wherein a simulation condition is specified by a user, and the corresponding vertex is equivalent to the simulation condition during the simulation process. For example, a specific part of an object is not deformable or an object is immovable. The other type of detection is dynamic detection, wherein a constraint is added when a vertex exceeds a threshold preset by a user during the simulation process. For example, a correction is carried out when the deformation of an object exceeds a specific range.

When the updated state of one of the vertexes 110, 120, and 130 exceeds the predetermined simulation condition, a correction is performed according to the predetermined simulation condition. In the present embodiment, the simulation condition includes one of the length, angle, surface area, volume, stress, and strain of the 3D object 100. In addition, because the forces between the virtual vertex 140 and the vertexes 110, 120, and 130 are calculated through a spring model in the present embodiment, the step of performing the correction according to the predetermined simulation condition may further include specifying a spring deformation range of the spring model. Because the length constraint requests a specific distance to be kept between vertexes, the constraint can be expressed as:

f(xᵢ,yᵢ,zᵢ)=\sqrt{(xᵢ−xₖ)²+(yᵢ−yₖ)²+(zᵢ−zₖ)²}−Lⱼₖ

The constraint is satisfied when f(xᵢ,yᵢ,zᵢ)=0. After that, f(xᵢ,yᵢ,zᵢ) is differentiated to obtain extreme values f(xᵢ,yᵢ,zᵢ)/∂ₓ=0, f(xᵢ,yᵢ,zᵢ)/∂_{y}=0, and f(xᵢ,yᵢ,zᵢ)/∂_{z}=0. Thus, the correction values Δxᵢ=−Δf/fₓ, Δyᵢ=−Δf/f_{y}, and Δzᵢ=−Δf/f_{z} are obtained. The distances between the vertexes can be kept at a constant value according to these correction values.

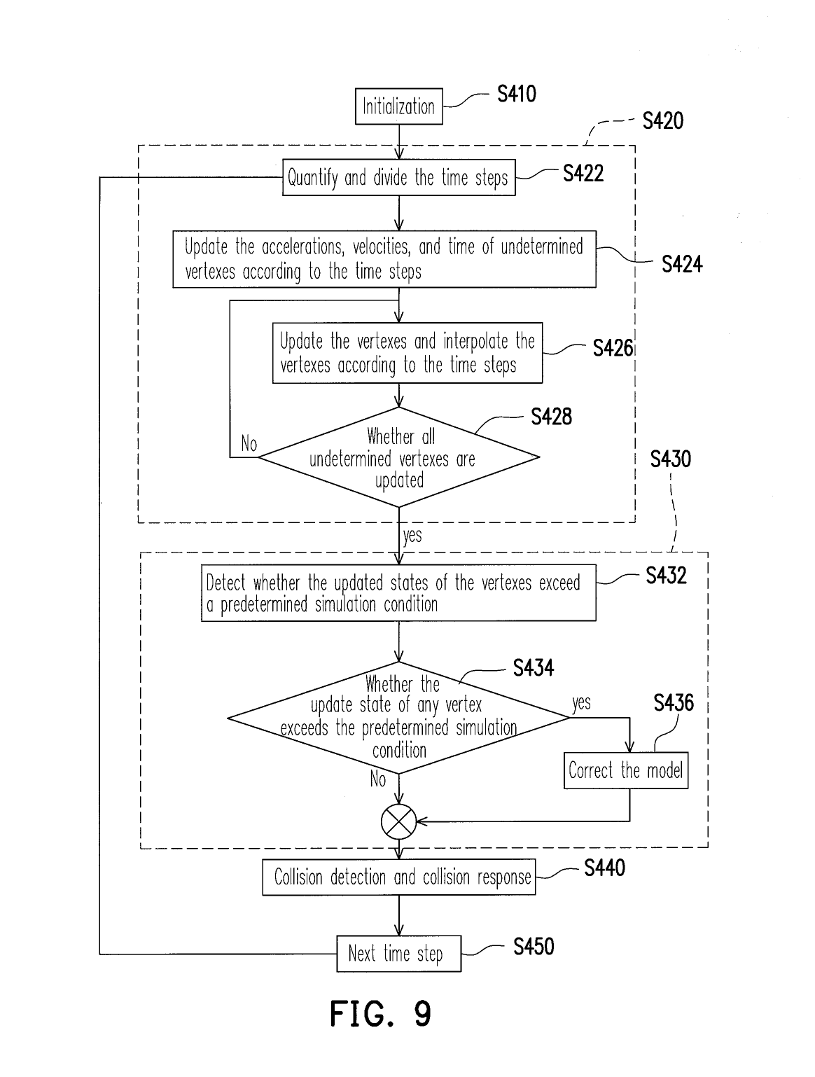

FIG. 9 is a flowchart of a collision simulation method of a 3D object according to another embodiment of the present invention. The flowchart in FIG. 9 is obtained by integrating the embodiments described above, and the embodiment illustrated in FIG. 9 will be described herein with reference to FIGS. 1, 3, 4, and 8. Referring to FIG. 9, first, in step S410, the parameters (for example, the position pᵢ, the velocity vᵢ, and the mass mᵢ, etc) of each vertex in the model are initialized.

Then, step S420 is executed, and the step S420 is corresponding to the steps of quantifying the time steps illustrated in FIG. 4. Step S420 may includes a plurality of sub steps S422-S428. In step S422, the time steps are quantified and divided into a plurality of equal parts. Then, in step S424, the accelerations, velocities, and time of undetermined vertexes are updated according to the time steps. Next, in step S426, the vertexes are updated and all required information is interpolated according to the quantified time steps. Thereafter, in step S428, whether all the undetermined vertexes have been updated is determined.

Step S430 is executed after all the vertexes are updated. Step S430 is corresponding to the model correction process illustrated in FIG. 8 and further includes a plurality of sub steps S432-S436. First, in step S432, whether the updated states of the vertexes exceed a predetermined simulation condition is detected. Then, in step S434, whether the updated state of a vertex exceeds the simulation condition is determined If the updated state of a vertex exceeds the simulation condition, the model is corrected (step S436). Otherwise, step S440 is executed to carry out collision detection and collision response.

Step S440 is corresponding to the collision detection and collision response process illustrated in FIG. 1 and which will not be described herein. After the collision detection and collision response process is finished, a next time step is entered (step S450). Accordingly, the physical response of the 3D object is simulated through the process described above.

As described above, in embodiments, the resolution of the collided position is increased by generating virtual vertexes at where the 3D object is collided, so that the simulation precision is improved. Additionally, the calculation load is reduced by quantifying the time steps. Moreover, appropriate simulation constraints can be added to the system during the simulation process such that the application range of the physical simulation technique is broadened.

It will be apparent to those skilled in the art that various modifications and variations can be made to the structure of the embodiments without departing from the scope or spirit of the invention. In view of the foregoing, it is intended that the embodiments cover modifications and variations provided they fall within the scope of the following claims and their equivalents.

What is claimed is:

1. A collision simulation method of a three dimensional (3D) object, wherein the 3D object comprises a plurality of polygonal meshes, the collision simulation method comprising:
detecting a collision between the polygonal meshes and an object;
when one of the polygonal meshes is collided by the object, generating at least one virtual vertex at a first position where the polygonal mesh is collided by the object, wherein the polygonal mesh comprises a plurality of vertexes;
connecting the at least one virtual vertex to the vertexes to form a plurality of sub meshes;
calculating a force between the object and the at least one virtual vertex to update the first position of the virtual vertex into a second position; and
calculating forces between the at least one virtual vertex and the vertexes according to the second position of the at least one virtual vertex, so as to update positions of the vertexes.

2. The collision simulation method according to claim 1, wherein the forces between the at least one virtual vertex and the vertexes are calculated in a spring model.

3. The collision simulation method according to claim 2, wherein the step of calculating the forces between the at least one virtual vertex and the vertexes comprises:
calculating a mass distribution of the vertexes;
recording a first length relationship between the at least one virtual vertex and the vertexes before the virtual vertex is updated;
recording a second length relationship between the at least one virtual vertex and the vertexes after the virtual vertex is updated; and
calculating velocities and the positions of the vertexes according to the mass distribution, the first length relationship, and the second length relationship in the spring model.

4. The collision simulation method according to claim 1, wherein after the positions of the vertexes are updated, the collision simulation method further comprises:
determining whether the object leaves a spatial range formed by the at least one updated virtual vertex and the updated vertexes; and
if the object leaves the spatial range, deleting the at least one virtual vertex.

5. The collision simulation method according to claim 1, wherein the step of updating the positions of the vertexes comprises:
quantifying time steps of the vertexes; and
sequentially updating the vertexes according to the quantified time steps until the vertexes respectively reach a system time.

6. The collision simulation method according to claim 5, wherein the step of quantifying the time steps of the vertexes comprises:
quantifying the time steps of the vertexes into Δtᵢ^{q}=2ⁱ⁻¹Δt₁, wherein i≧1, and Δt₁is a smallest one of the time steps of the vertexes.

7. The collision simulation method according to claim 1 further comprising:
detecting whether states of the updated vertexes exceed a predetermined simulation condition; and
when the state of one of the updated vertexes exceeds the predetermined simulation condition, performing a correction according to the predetermined simulation condition.

8. The collision simulation method according to claim 7, wherein the forces between the at least one virtual vertex and the vertexes are calculated in a spring model, and the step of performing the correction according to the predetermined simulation condition comprises:
specifying a spring deformation range of the spring model.

9. The collision simulation method according to claim 7, wherein the predetermined simulation condition comprises one of a length, an angle, a surface area, a volume, a stress, and a strain of the 3D object.

10. The collision simulation method according to claim 1, wherein the polygonal meshes are triangular meshes.
